(19) United States
(12) Patent Application Publication
(10) Pub. No.: US 2025/0385997 A1
(43) Pub. Date: Dec. 18, 2025

(54) Method for Displaying Two or More Different Images on a Single Screen to Two or More Viewers Positioned at Different Angles

(71) Applicants: Elizabeth B. Jacoby, Little Rock, AR (US); Gregory Donald Carson, Rancho Cucamonga, CA (US)

(72) Inventors: Elizabeth B. Jacoby, Little Rock, AR (US); Gregory Donald Carson, Rancho Cucamonga, CA (US)

(21) Appl. No.: 18/950,513

(22) Filed: Nov. 18, 2024

Related U.S. Application Data
(63) Continuation-in-part of application No. 18/746,569, filed on Jun. 18, 2024, now abandoned.

(51) Int. Cl. H04N 13/279; H04N 13/296; H04N 13/368; H04N 13/383; H04N 13/398

(52) U.S. Cl. CPC H04N 13/279; H04N 13/296; H04N 13/368; H04N 13/383; H04N 13/398

(57) ABSTRACT

This invention enables a digital display to project distinct images to two, three, four, or more viewers based on their viewing angles. Utilizing a combination of directional light control technologies, such as parallax barriers or lenticular displays, and a digital mask algorithm, the system dynamically adjusts pixel brightness and light directionality to personalize content delivery. Real-time sensor feedback, including gyroscopes, cameras, and eye-tracking sensors, continuously updates viewer positions and angles to optimize the experience. This system is applicable in entertainment, retail, education, healthcare, and collaborative workspaces, offering a seamless multi-view experience without interference between users. It enhances privacy, customization, and interaction, providing a flexible and cost-effective solution for personalized viewing on smartphones, tablets, computers, and public displays.

### CROSS-REFERENCE TO RELATED APPLICATIONS

This application is a continuation-in-part of U.S. patent application Ser. No. 18/746,569, filed on Jun. 18, 2024, by Elizabeth B. Jacoby, titled “Neck Position Training Method.” This application claims the benefit of priority to the aforementioned application under 35 U.S.C. § 120. The entire contents of the aforementioned application are hereby incorporated by reference as permitted under 37 C.F.R. § 1.57 for all purposes.

### BACKGROUND OF THE INVENTION

### Technical Field

This invention relates generally to a multi-view digital display system for enhancing privacy and personalization. More particularly, this invention is directed to an apparatus or device capable of applying digital masks to screen content, allowing the display of two, three, four, or more different images to separate viewers based on their viewing angles, enabling distinct experiences for each user on smartphones, tablets, computers, and other electronic screens. This system can serve multiple simultaneous users by dynamically adjusting content and ensuring personalized and secure viewing for each individual.

This invention also pertains to apparatuses and devices that improve screen functionality by dynamically adjusting the visual output based on the viewer's angle, allowing for the customized delivery of content while maintaining privacy. The method is compatible with a wide range of digital devices, including laptops, desktops, smart TVs, and public information displays, ensuring personalized and secure content delivery for multiple users on a single screen. In addition to enhancing the user experience, the system offers privacy protection, making it suitable for environments like public spaces, offices, and collaborative workstations.

The invention is grounded in the field of multi-view digital display technology, specifically related to image and video processing systems that differentiate screen content based on viewing angles. This field includes the development of apparatuses and methods for selectively altering the visual output to display distinct images to multiple viewers, dynamically adjusting contrast, reflections, and color based on each viewer's angle. The system provides real-time content personalization and visibility enhancement, ensuring privacy and content differentiation for each user. This invention may be classified under U.S. Patent Classification codes related to multi-view electronic displays, digital image processing, and privacy-enhancing technologies. These classifications encompass innovations designed to deliver customized content and protect sensitive information for users on devices such as smartphones, tablets, computers, smart TVs, and public display systems.

Additionally, this invention leverages software and hardware-based solutions to achieve angle-based visual differentiation. By processing the viewing angles of multiple users in real-time and rapidly refreshing the display, the system can deliver personalized content for multiple users without requiring specialized hardware, making it adaptable across various devices and platforms. The invention addresses challenges in multi-view digital displays, providing a solution for multi-user settings that ensures both content customization and privacy.

### Background Art

Several current technologies provide functionality similar to the claims of the present invention for displaying different images to viewers based on their viewing angles. These technologies primarily focus on enabling multi-view displays and personalizing content for different users on digital screens, including smartphones, tablets, and computers.

Physical Privacy Filters—Description: Privacy filters are physical screens that narrow the viewing angle, ensuring that only the person directly in front of the screen can see the content clearly. Utility: While privacy filters primarily address privacy concerns by restricting the viewing angle, they offer limited customization and cannot display distinct images to multiple viewers based on their positions.

Parallax Barrier Displays—Description: Parallax barrier technology uses a physical barrier on the screen to send different light rays to different viewing angles, allowing multiple viewers to see different content based on their relative positions. Utility: Parallax barrier displays enable a multi-view experience, but often require specialized hardware, limiting their flexibility. They are also limited in their ability to dynamically adjust content for more than two viewers or provide real-time changes for multiple simultaneous users.

Software-Based Multi-View Solutions (Dynamic Blurring)—Description: Software solutions offer the ability to display different content to users based on their viewing angle by using sensors and real-time adjustments. These solutions can obscure parts of the screen based on the viewer's position or display personalized content for different users. Utility: Similar to the claims of the present invention, these software-based solutions aim to show different content to multiple viewers, but they typically rely on device-specific hardware and may not offer the full range of dynamic, real-time adaptation or customization proposed by the invention.

Advanced Display Technologies (Micro-LED Displays with Directional Light Control)—Description: Micro-LED displays with directional light control allow light emission to be targeted toward specific viewing angles, potentially showing different images to viewers based on their positions without additional filters or software. Utility: These hardware-driven displays represent a solution to multi-view problems, but they are still in development and may not provide the flexibility or real-time dynamic adjustment needed for practical, everyday applications involving multiple simultaneous viewers.

### Advantages of the Present Invention

Dynamic and Context-Aware Adjustments-Advantage: The claims describe a system that dynamically adjusts content based on each viewer's position and viewing angle. If the hardware and display refresh rates are sufficiently fast, the present invention can serve two, three, four, or more simultaneous viewers, each receiving distinct, personalized content based on their specific location in front of the screen. The system optimizes content delivery based on real-time data such as viewer movement and angle, seamlessly switching between distinct images as needed. Existing Art: Parallax barrier displays and physical privacy filters do not dynamically adjust content based on environmental factors or offer real-time customization for multiple simultaneous viewers.

Selective Content Delivery—Advantage: The invention enables selective content delivery to specific regions of the screen, based on each viewer's position. This provides a personalized experience for multiple viewers without disrupting the content for others. The system can now serve two, three, four, or more viewers simultaneously, ensuring that each viewer sees distinct content tailored to their position, provided the hardware can refresh the screen fast enough. Existing Art: Current multi-view technologies (such as parallax barriers) are limited in their ability to deliver multiple dynamic views. They typically present fixed content for a limited number of viewers and lack real-time, multi-user customization.

Integration with Existing Hardware—Advantage: This solution can be implemented through software, making it compatible with existing devices such as smartphones, tablets, and computers, without the need for specialized hardware. This enhances flexibility, usability, and cost-effectiveness, while also supporting the possibility of serving multiple simultaneous viewers if the display refresh rate is fast enough. Existing Art: Parallax barrier technology and directional light control displays generally require specialized hardware, limiting their application across a wide range of devices and environments. Additionally, these systems often cannot serve more than two users in real-time.

Enhanced Visibility in Bright Conditions—Advantage: The present invention includes techniques to optimize content visibility under various lighting conditions, such as bright ambient light. This ensures that multiple viewers, whether two, three, or four, can see their personalized content clearly, even in bright environments, while protecting sensitive information. Existing Art: Current multi-view technologies are typically designed for indoor environments with controlled lighting and may not perform well in outdoor or bright settings, especially when serving multiple viewers.

User Customization and Control—Advantage: The system allows users to customize the content displayed on the screen based on their preferences, offering a highly personalized viewing experience for each individual. This feature provides flexibility for two or more simultaneous viewers, with the system dynamically adjusting content for each viewer's position. Existing Art: Many current solutions offer limited or no user customization, and those that support multi-view experiences typically do not allow multiple users to control or customize what content they see.

Hybrid Approach with Existing Filters-Advantage: The digital mask technology described in the patent claims can be combined with existing physical privacy filters or parallax barriers, enhancing both privacy and content customization. This adaptability allows the solution to be integrated into different settings and scenarios while supporting multi-viewer use for two or more viewers. Existing Art: Existing technologies typically do not offer seamless integration between physical privacy filters and digital content customization, nor do they allow for multiple distinct content views for more than two users.

### The Present Invention's Improvements over Existing Technologies

The patent claims of the present invention describe a dynamic, real-time, and customizable approach to displaying different content to multiple viewers based on their viewing angles. The system's ability to display up to two, three, four, or more distinct views simultaneously, without the need for specialized hardware, makes it more flexible and widely applicable. This approach addresses the limitations of existing multi-view technologies and privacy filters by offering:

Enhanced functionality: Dynamic, real-time content adjustment based on viewer position, capable of supporting multiple viewers.

User control: Customizable content for personalized experiences for two or more viewers.

Improved usability: Optimized performance under varying environmental conditions, including bright light.

Cost-effectiveness: Software-based implementation that can integrate with existing hardware.

### Need for the Present Invention

In light of the foregoing prior art, there is a need for a more adaptive and flexible solution capable of displaying different content to multiple viewers based on their viewing angles. Current technologies, such as static physical privacy filters and hardware-dependent multi-view displays, often lack the flexibility required for real-time, personalized content delivery in dynamic environments (e.g., public spaces, shared screens). These solutions fail to offer real-time adjustments for multiple users, often compromising the viewing experience or failing to tailor content appropriately for different viewers.

The present invention addresses these shortcomings by providing a software-based solution that delivers up to two, three, four, or more different images to viewers, adjusting content in real-time based on their specific viewing angles. If the display hardware is sufficiently fast to refresh the screen, the system ensures that each viewer experiences tailored content, with optimizations for ambient conditions (e.g., bright light) to provide a personalized, efficient, and flexible user experience.

### BRIEF SUMMARY OF THE INVENTION

The invention relates to multi-view display technology that enables two or more distinct images to be displayed on the same screen and viewed by different people, depending on their viewing angles. The inventive concept centers around a digital masking technique, where a numerical array dynamically controls which content is visible to each viewer based on real-time positional data. This technique allows for the dynamic control of image contrast, reflections, and visibility in specific areas of the screen, delivering personalized content while obscuring irrelevant information from each user's perspective.

Unlike conventional privacy or multi-view systems that rely on physical privacy filters or hardware modifications like parallax barriers, this invention offers a software-driven, device-independent solution. The digital mask is applied dynamically, adjusting in real time based on environmental factors such as ambient light and viewer orientation. This adaptability enables the system to seamlessly show different images to multiple viewers simultaneously, making it highly versatile in shared environments like offices, public spaces, or collaborative workstations.

Key objectives include providing a flexible, customizable system that delivers tailored content to multiple viewers without requiring additional hardware. The digital mask enhances both usability and privacy, addressing the limitations of prior multi-view display systems, which often suffer from fixed configurations or lack adaptability to different user conditions.

### Related Art and Problems in the Prior Art

Physical Privacy Filters: Privacy filters narrow the viewing angle to obscure screen content from side viewers. While effective for privacy, they are static and limited to specific screen sizes, making them cumbersome for multi-view applications. Problem: These filters are fixed and cannot adapt to multiple viewers, requiring additional hardware to provide personalized content.

Parallax Barrier and Lenticular Displays: These display technologies enable different images to be shown to different viewers based on their angles, achieved through directional light control. However, they rely on precise hardware configurations. Problem: Such systems are hardware-dependent and lack adaptability for different device types and environments. They offer no dynamic control based on real-time conditions or individual preferences.

Software-Based Multi-View Solutions: Some software applications simulate a multi-view effect, but these are often restricted to specific hardware and fail to provide fine-grained control over content for individual viewers. Problem: Current software solutions typically lack the ability to dynamically adjust image visibility based on individual user angles, limiting their flexibility for practical use in shared environments.

### Problems Solved by the Invention

Dynamic and Context-Aware Adjustments: The digital mask technology offers real-time adjustments based on user position, viewing angle, and environmental conditions such as ambient light. This ensures that privacy and visibility are optimized for each viewer. Advantage: By leveraging device sensors like gyroscopes, cameras, or light sensors, the digital mask ensures that each user sees the appropriate image, even as conditions change.

Selective Image Delivery: The invention allows specific areas of the screen to be customized, delivering different content to different users based on viewing angles, without disrupting the experience for others. Advantage: Unlike existing technologies, this system applies the effect dynamically and selectively, allowing viewers to experience tailored content without additional hardware constraints.

User Customization: Users can manually adjust or automate the content displayed, providing flexibility and personalization that is absent from prior systems. Advantage: This level of control surpasses fixed hardware solutions, making the experience more user-centric and adaptable to various scenarios.

Software-Based, Device-Independent Solution: The digital mask can be implemented on a wide range of devices, making it more accessible and cost-effective compared to hardware-dependent systems like parallax displays. Advantage: The solution integrates seamlessly with existing hardware, eliminating the need for specialized multi-view displays. Integration with Hardware

Real-Time Processing and Sensor Input: The software-driven approach interacts with a device's hardware components (e.g., sensors and display units) to dynamically adjust the displayed images. For example, gyroscopes, cameras, and ambient light sensors detect user positions and conditions, ensuring the appropriate content is delivered.

User Interface for Customization: The invention offers an intuitive user interface that allows viewers to manually customize which content is displayed, offering a more flexible experience compared to static multi-view solutions.

Hybrid Functionality with Physical Filters: The system can be used in conjunction with physical privacy filters, enabling users to maximize privacy while also delivering tailored content to each viewer.

### Advantages over Prior Systems

The invention advances beyond traditional software by integrating with existing device hardware to create a dynamic and context-aware system for delivering multiple images to different viewers on the same screen. This approach offers a scalable and customizable solution that significantly improves upon prior multi-view display systems, which often lack flexibility, adaptability, and user control. The system's integration with sensors and real-time processing ensures that it can cater to a wide range of applications, from entertainment to professional use, offering a comprehensive multi-view experience without the need for additional specialized hardware.

According to a first aspect of the invention, there is a method for displaying distinct images on a single screen to multiple viewers positioned at different angles. The method includes receiving multiple image or video data inputs, generating numerical masks, dynamically adjusting light emission, and utilizing real-time sensor data to continuously update viewing angles for each viewer. An advantage of this method is that it allows the display of personalized content to two, three, four, or more simultaneous viewers without requiring specialized hardware, providing a flexible, software-driven solution for multi-user environments.

Further features of the invention are disclosed as follows: According to a second aspect of the present invention, the method includes generating numerical masks based on algorithms that consider pixel arrangement, viewer angle, and content characteristics to optimize the visibility and clarity of each image for its respective viewer while minimizing image overlap or interference between viewers.

According to a third aspect of the present invention, the method further includes the use of a variety of position-tracking sensors, such as gyroscopes, infrared sensors, cameras, ultrasonic sensors, and eye-tracking sensors. An advantage of using these sensors is that they enable continuous real-time updates of viewer position and angle, ensuring accurate and responsive content delivery to each user.

According to a fourth aspect of the present invention, the method includes detecting variations in ambient lighting conditions and adjusting the numerical masks and light directionality to enhance image visibility. An advantage of this feature is that it ensures optimal image clarity and visibility in various lighting environments, improving user experience.

According to a fifth aspect of the present invention, the light directionality is controlled by directional light management technology, such as lenticular lenses, parallax barriers, micro-lens arrays, or digital holography elements. An advantage of using this directional light control technology is that it enables precise projection of images to specific viewing angles, reducing image leakage between viewers.

According to a sixth aspect of the present invention, the method includes detecting the head orientation and eye gaze of each viewer using biometric sensors and dynamically adjusting the numerical masks and light directionality accordingly. An advantage of this feature is that it ensures optimal image clarity and visibility for each viewer, even as they move relative to the screen.

According to a seventh aspect of the present invention, the method includes a user interface that allows each viewer to manually customize the image or video content displayed at their respective viewing angles. An advantage of this customization feature is that it offers greater flexibility and personalization for users, allowing them to tailor their viewing experience based on individual preferences.

According to an eighth aspect of the invention, there is a system for displaying distinct images to multiple viewers on a single screen. The system includes a display device with integrated directional light control technology, a plurality of position-detecting sensors, and a processor configured to apply numerical masks and adjust light directionality based on real-time sensor feedback. An advantage of this system is that it provides a comprehensive, hardware-integrated solution capable of delivering personalized content to multiple users without interference, improving user interaction and privacy.

Further features of the invention are disclosed as follows: According to a ninth aspect of the present invention, the directional light control technology is selected from lenticular lenses, parallax barriers, micro-lens arrays, or holography elements. An advantage of this feature is the ability to project high-resolution images to different viewing angles, ensuring each viewer receives a clear, high-quality image.

According to a tenth aspect of the present invention, the system includes compensating for changes in ambient lighting conditions by adjusting the numerical masks and light directionality. An advantage of this feature is maintaining optimal image visibility under various environmental lighting conditions, enhancing the system's adaptability.

According to an eleventh aspect of the present invention, the system includes a user interface allowing each viewer to manually customize the content displayed at their respective viewing angles. An advantage of this feature is the ability for users to adjust image settings such as brightness, contrast, and color, providing a more personalized and adaptable viewing experience.

According to a twelfth aspect of the present invention, the sensors used in the system are selected from gyroscopes, infrared sensors, ultrasonic sensors, cameras, and eye-tracking devices. An advantage of these advanced sensors is their ability to continuously track the position, head orientation, and eye gaze of each viewer, providing accurate and responsive content adjustments in real time.

According to a thirteenth aspect of the present invention, the processor utilizes real-time data from the sensors to dynamically adjust light directionality and numerical masks. An advantage of this feature is ensuring that image clarity is maintained, even as viewers change positions or angles, improving the system's adaptability in dynamic environments.

According to a fourteenth aspect of the invention, there is a non-transitory computer-readable medium storing instructions that, when executed by a processor, cause a display device to perform a method for displaying distinct images to multiple viewers positioned at different angles. An advantage of this computer-readable medium is that it allows the method to be deployed across different systems and devices without the need for additional hardware, increasing the system's flexibility.

According to a fifteenth aspect of the present invention, the non-transitory computer-readable medium adjusts numerical masks and light directionality to compensate for changes in ambient lighting conditions. An advantage of this feature is maintaining optimal image visibility and content clarity across a wide range of lighting environments.

According to a sixteenth aspect of the present invention, the non-transitory computer-readable medium tracks head position, eye gaze, and movement of viewers using biometric sensors. An advantage of this feature is that it allows the system to dynamically adjust the image display to maintain optimal visibility for each viewer as they move relative to the screen.

According to a seventeenth aspect of the present invention, the non-transitory computer-readable medium includes a user interface allowing viewers to manually select, customize, or switch between different image or video data inputs. An advantage of this feature is offering viewers enhanced control over their viewing experience, providing greater flexibility and personalization in multi-user environments.

### Key Advantages

Personalized Multi-View Experience: Each viewer can see tailored content on the same screen, enhancing usability in shared environments such as public displays, gaming, or entertainment systems. This allows for individual experiences without the need for separate devices. The system's ability to serve multiple viewers, showing distinct content to each based on their viewing angle, creates a more personalized and immersive experience.

Dynamic Real-Time Adjustments: The system adapts in real-time using sensors like gyroscopes, cameras, or ambient light detectors, dynamically adjusting the display based on each viewer's angle and environmental conditions. This ensures optimal content delivery for each viewer under varying conditions, offering a seamless and responsive experience as users move relative to the screen.

Device Independence: The invention is software-driven and compatible with a wide range of digital devices, such as smartphones, tablets, and computers, allowing it to be implemented without the need for specialized hardware. This device independence reduces costs and increases accessibility, making it practical for broad applications across consumer electronics and public display systems.

Enhanced Privacy and Usability: The invention ensures privacy by displaying different content to each viewer, allowing sensitive information to be hidden from unauthorized viewers. Additionally, the system selectively applies effects like contrast and reflection adjustments, enhancing both privacy and usability by ensuring each viewer sees only the content meant for them.

Improved Viewing in Various Conditions: By dynamically controlling light emission and adjusting display characteristics, the system performs effectively even in high ambient light environments, where traditional solutions might struggle. This adaptability ensures that content remains clear and visible in diverse lighting conditions, enhancing the overall viewing experience.

Flexibility and Scalability: These advantages make the invention a flexible, efficient, and scalable solution for multi-view display technology, offering significant improvements over existing methods. The system's ability to adapt to different devices and environments, combined with its real-time adjustment capabilities, provides a superior multi-user experience without requiring additional specialized hardware.

The present invention is significantly more than mere software due to its integration of hardware components, its real-time interaction with environmental data, and its use of display technology manipulation to achieve multi-view functionality.

Real-Time Sensor Integration: The invention leverages hardware sensors such as gyroscopes, accelerometers, cameras, and ambient light detectors to gather real-time data about the environment and the viewer's position. These sensors provide critical feedback to the software, enabling it to adjust the content displayed based on the viewer's angle relative to the screen. For example, when multiple viewers are seated at different angles, the sensors detect each viewer's position, and the system uses this data to display distinct content to each user. This real-time interaction between hardware (sensors) and software ensures the digital mask is continuously adjusted based on changes in viewing angles, making the system responsive and adaptable. This sensor integration moves beyond typical software solutions, which usually lack continuous environmental feedback and dynamic adjustments.

Control Over Display Hardware: The invention requires precise control over the display hardware, including the device's graphics processing unit (GPU) and screen. The digital mask dynamically adjusts brightness, contrast, and color, altering the display output for different viewing angles. This control over the hardware ensures that light is emitted in specific directions, allowing multiple viewers to perceive different content. Directional light control technologies, such as lenticular lenses or parallax barriers, are used to manage how light is directed. This level of control over hardware surpasses typical software applications, which cannot independently control light emissions from the screen. The invention combines software-driven content selection with hardware-based light management, ensuring the correct image is visible to each viewer based on their position.

Interaction Between Software and Physical Display: The invention goes beyond simple pixel manipulation by integrating with the physical components of the display. The system calibrates viewing angles in real-time, detecting where viewers are positioned and adjusting the light emission accordingly. This allows each viewer to see distinct content without overlapping images, similar to technologies like lenticular or parallax displays, but enhanced through dynamic software control. The invention's ability to combine software-based content management with hardware-based light emission control provides a true multi-view experience, allowing multiple viewers to share a screen while seeing different images tailored to their viewing angles.

User Interaction with Hardware: The invention includes physical controls or tactile interfaces that allow users to manually adjust their viewing preferences. For instance, viewers can adjust the intensity of the display, select which content they want to view, or customize image settings like brightness and contrast. These physical interactions further differentiate the invention from purely software-based solutions, as it involves direct user input to hardware components such as buttons or sliders, allowing users to influence the content display based on their preferences and position relative to the screen.

The invention is significantly more than mere software because it integrates multiple hardware components, including sensors and the display system, to provide real-time, dynamic adjustments based on viewer positions and environmental factors. By controlling light emissions and interacting with the display hardware, the system creates a multi-view experience that cannot be achieved by software alone. The invention's ability to manage both content and the physical aspects of display technology makes it a comprehensive solution, surpassing traditional software-based privacy and viewing systems.

The invention will now be described, by way of example only, with reference to the accompanying drawings in which:

### BRIEF DESCRIPTION OF THE SEVERAL VIEWS OF THE DRAWINGS

FIG. 1 is a flowchart of the method for displaying distinct images on a single screen to multiple viewers positioned at different viewing angles according to the invention;

FIG. 2 is a flowchart of the system for displaying distinct images to multiple viewers on a single screen according to the invention;

FIG. 3 is a flowchart of the method of the non-transitory computer-readable medium storing instructions that, when executed by a processor, cause a display device to perform a method for displaying distinct images to viewers positioned at different angles according to the invention; and

FIG. 4 is an above view of two viewers positioned at different viewing angles watching a display of two distinct images on a single screen according to the invention.

### DETAILED DESCRIPTION OF THE INVENTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” etcetera, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Throughout this specification, the word “comprise,” or variations thereof such as “comprises” or “comprising,” will be understood to imply the inclusion of a stated element, integer or step, or group of elements integers or steps, but not the exclusion of any other element, integer or step, or group of elements, integers or steps.

Index of Labelled Features in Figures. Features are listed in numeric order by Figure in numeric order.

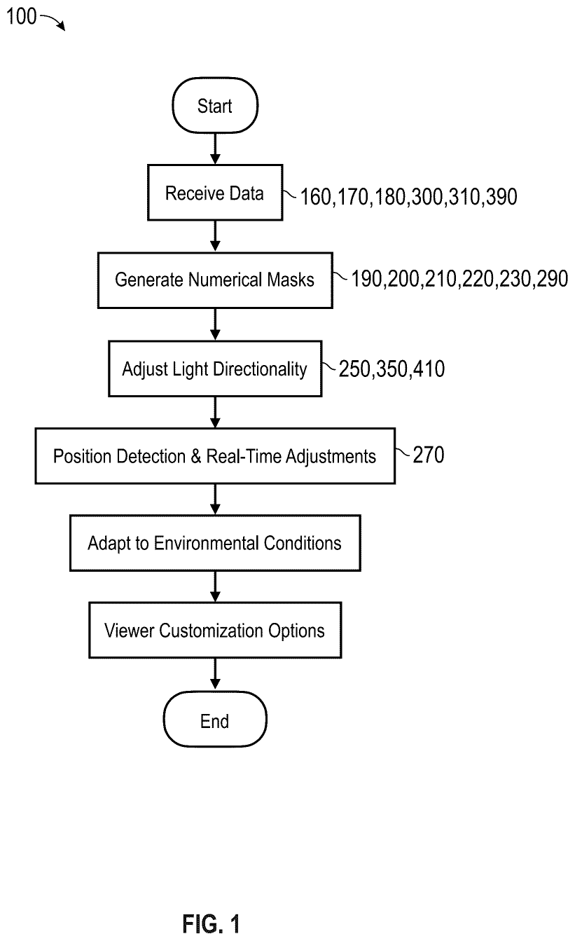

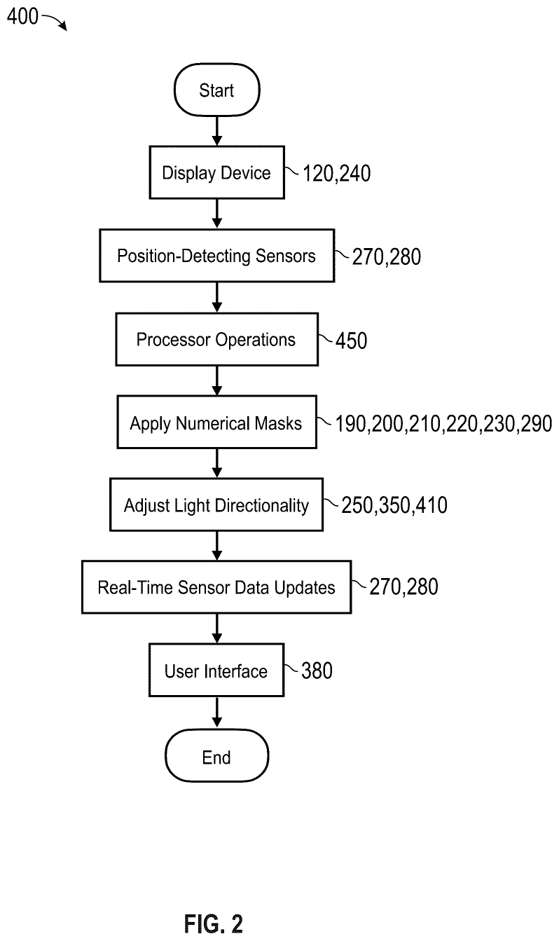

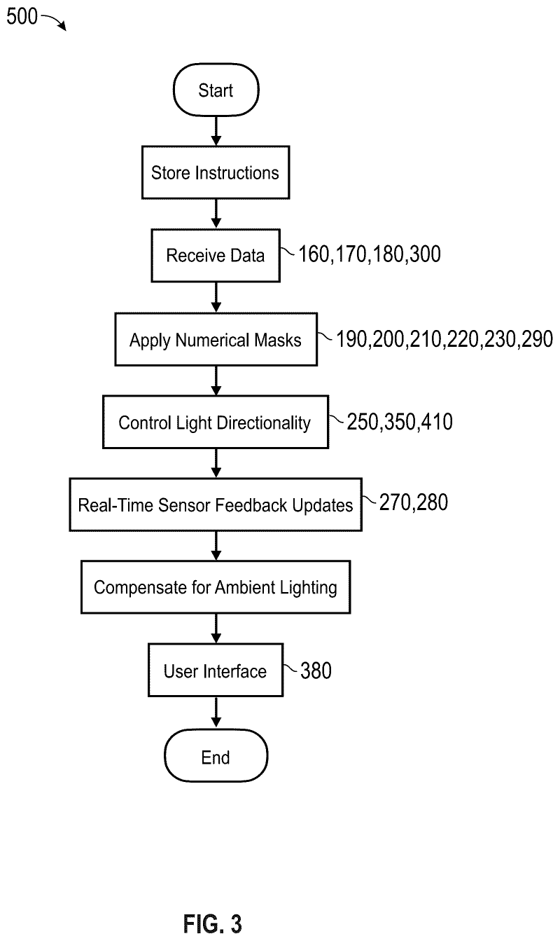

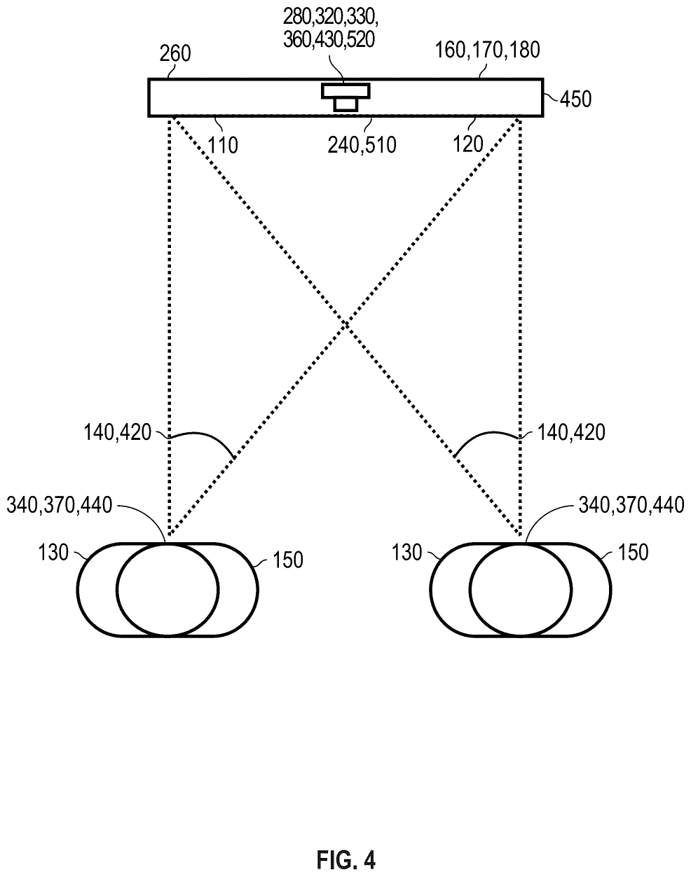

Referring to the Figures, there is shown in FIGS. 1, 2, 3, and 4 the following features:
Element 100 which is a method for displaying distinct images on a single screen to multiple viewers positioned at different viewing angles.
Element 110 which is a distinct image.
Element 120 which is a single screen.
Element 130 which is a viewer.
Element 140 which is a viewing angle.
Element 150 which is a position.
Element 160 which is a plurality of image data inputs.
Element 170 which is a plurality of video data inputs
Element 180 which is a distinct content.
Element 190 which is a set of numerical masks
Element 200 which is a brightness.
Element 210 which is a contrast.
Element 220 which is a color.
Element 230 which is a pixel visibility.
Element 240 which is a display.
Element 250 which is a light directionality.
Element 260 which is a display hardware.
Element 270 which is a real-time position data.
Element 280 which is a sensor.
Element 290 which is a pixel arrangement.
Element 300 which is a content characteristics.
Element 310 which is a visibility and clarity of an image.
Element 320 which is a position-tracking device.
Element 330 which is a group consisting of gyroscopes, infrared sensors, cameras, ultrasonic sensors, and eye-tracking devices.
Element 340 which is a head position, an eye gaze, and a distance from the single screen of the viewer.
Element 350 which is a directional light management technology.
Element 360 which is a group consisting of lenticular lenses, parallax barriers, micro-lens arrays, or digital holography elements.
Element 370 which is an orientation and a movement of a head and an eye gaze.
Element 380 which is a user interface.
Element 390 which is an image content or a video content.
Element 400 which is a system for displaying distinct images to multiple viewers on a single screen.
Element 410 which is an integrated directional light control technology.
Element 420 which is a specific viewing angle.
Element 430 which is a position-detecting sensor.
Element 440 which is a position, a viewing angle, a head movement, and an eye gaze.
Element 450 which is a processor.
Element 500 which is a non-transitory computer-readable medium storing instructions that, when executed by a processor, cause a display device to perform a method for displaying distinct images to viewers positioned at different angles.
Element 510 which is a group of pixels.
Element 520 which is a biometric sensor.

The invention is significantly more than mere software due to its seamless integration with hardware components, real-time interaction with environmental data, and manipulation of display technology to achieve a multi-view experience. This holistic approach merges cutting-edge hardware feedback with sophisticated software algorithms, resulting in an innovative system capable of displaying different content to multiple viewers based on their specific viewing angles. The system dynamically adjusts light emission and content presentation, creating a personalized viewing experience that goes beyond traditional software-only solutions.

Real-Time Sensor Integration: The invention leverages an array of hardware sensors, such as gyroscopes, accelerometers, and ambient light sensors, to gather real-time data about the device's environment and the relative positions of its viewers. These sensors act as the system's eyes and ears, continuously monitoring the environment to adjust content dynamically for each user. For instance, if multiple users are positioned at different angles in front of the screen, the sensors detect their respective viewing positions. This sensor data is fed into the system in real-time, enabling it to compute which content should be displayed for each viewer. Gyroscopes and accelerometers track the exact angle from which each user is viewing the screen, while ambient light sensors ensure optimal contrast and color calibration based on external lighting conditions. This dynamic feedback loop between sensors and software guarantees that each viewer's content is perfectly tailored to their position, providing a true multi-view experience. Unlike conventional software relying on static inputs or fixed settings, this system adapts instantly to changes in the environment and user behavior, offering a rich and fluid visual experience unmatched by traditional software-only systems.

Control Over Display Hardware: The invention operates at the hardware level, interfacing with the device's GPU and display controller to manipulate how light is emitted from the screen. This goes beyond simple pixel manipulation—by controlling brightness, contrast, and color saturation dynamically, the system adjusts the content shown to each viewer based on their viewing angle. For instance, the display can direct light in specific directions using parallax barriers or lenticular lenses, ensuring that each viewer perceives only the content intended for them. This precise control over light projection is critical to the multi-view functionality, as it enables different users to see different images from the same screen without interference. Such control is impossible with software alone, as it requires the system to directly manage the light emissions from the display hardware, creating a rich, immersive multi-view experience.

Interaction Between Software and Physical Display: The invention involves more than simple screen partitioning; it achieves true multi-view functionality by integrating with display hardware and leveraging real-time data from sensors to calibrate viewing angles. As users move or adjust their position, the system recalibrates the display in real time, ensuring each viewer receives the correct content. Unlike traditional systems that divide the screen into sections, this invention manipulates how light is emitted from the display itself. By projecting different light paths, the system ensures each viewer sees a different image based on their viewing angle. This technology is similar to lenticular displays but is enhanced through software-driven content management that allows for more flexibility and customization. The combination of hardware-based light control and software-driven content management enables a dynamic, immersive multi-view experience where multiple users can share the same screen but perceive distinct content tailored to their viewing angle.

User Interaction with Hardware: The system includes physical controls or tactile interfaces that allow users to interact directly with the hardware to customize their viewing preferences. For instance, users can adjust display intensity, select which content they want to view, or calibrate the display to optimize the content based on their position. These physical input devices—such as sliders, buttons, or on-screen controls—provide an additional layer of customization, enabling users to interact with the system at a hardware level. This interaction goes beyond standard software solutions, where user control is typically limited to settings within an application. Instead, the invention allows users to influence how the display functions, making it adaptable and customizable for specific viewing scenarios.

The invention is significantly more than mere software because it integrates multiple hardware components, including real-time sensors and display technology, to provide dynamic adjustments based on viewer positions and environmental factors. By controlling light emissions, managing display hardware, and interacting with tactile interfaces, the system offers a unique multi-view experience that traditional software-only systems cannot achieve. The synergy between hardware and software makes it a comprehensive and powerful solution, capable of creating personalized viewing experiences for multiple users on the same device, transcending traditional viewing and privacy technologies.

The invention is significantly more than an abstract idea because it integrates seamlessly with physical hardware, addresses a specific technical problem, and provides a practical solution that operates across multiple devices. By dynamically interacting with and controlling physical components, this invention enhances the capability of digital displays to show distinct content to different viewers based on their viewing angles, firmly grounding it in the realm of tangible, real-world applications.

Linear Light Mask Technology: The invention also includes the use of a linear light mask, which operates as a digital mask or matrix array that overlays any displayed image as an electronic operation, transforming how the display content is presented. This mask modifies pixel brightness, hue, and saturation to create a focal brightness directly perpendicular to the front of the screen, while side viewing angles are significantly reduced or obscured. The mask is implemented in memory as a matrix of zeros and ones, filtering and transforming the image data passed through it. The result is a display where light and content are most visible when viewed directly in front of the screen, while off-angle viewers experience reduced visibility.

In one version of the invention, the blackout effect is created using the linear light mask to narrow the viewing angle, making it difficult for viewers at wider angles to see the content. This version restricts viewing to less than thirty degrees from the vertical axis, while another version narrows this further to fifteen degrees, ensuring that only users directly in front of the screen can see the content clearly.

Creation of a Digital Mask for Light Output Management: The process of creating a digital mask to manage light output involves designing a computational filter that dynamically adjusts the intensity and distribution of light. This filter ensures the accuracy and consistency of the image, particularly in scenarios where precise control of color and brightness is required. This technique allows the system to provide different images to different viewers by using sensors to detect their viewing angle and dynamically adjust the content in real-time, ensuring each viewer sees distinct content based on their position relative to the screen.

By integrating real-time sensor feedback and manipulating light projection, the invention surpasses conventional display technology. It uses advanced multi-view systems that interact with both hardware and software to provide tailored content for each viewer, offering an immersive, personalized experience on the same screen. The system's real-time adjustments enable seamless content delivery that adapts to user movement, environmental conditions, and viewing preferences, making it a versatile solution for a wide range of applications, from entertainment to professional environments.

### How to Make the Invention

Core Components and Materials: To create the invention, you will need a combination of hardware and software components that work together to provide a seamless multi-view experience. The essential components include:

Advanced Display Hardware: A screen capable of directional light control, such as a parallax barrier display or lenticular lens display. These display technologies direct light to specific angles, allowing the screen to project different images to viewers based on their positions.

Sensors: Utilize gyroscopes, accelerometers, or infrared cameras to detect the exact position and angle of each viewer relative to the screen. These sensors provide real-time feedback, allowing the content to be dynamically adjusted for each user.

Graphics Processing Unit (GPU): A powerful GPU is critical for real-time rendering and processing multiple images. It ensures smooth transitions between the distinct images displayed to different users, optimizing performance.

Digital Mask Software: This is the core algorithm responsible for applying a digital mask that modifies pixel brightness, contrast, and hue based on viewer angles. The algorithm adjusts the content in real-time based on sensor input.

Memory Storage: A memory module stores the matrix arrays, image data, and other digital content needed for processing light masks and visual data. This component ensures the system has access to all necessary content for multi-view operation.

Controller Interface: A user-friendly control interface allows users to interact with the system, customize their viewing preferences, and select content.

### Building the Digital Mask Algorithm

### Step 1: Define the Digital Mask

Matrix Array Representation: Develop the mask as a numerical array stored in the device's memory. Each value in the array corresponds to pixel brightness, hue, or color saturation. The mask ensures that light is brightest for viewers directly in front of the screen while reducing visibility for off-angle viewers.

### Step 2: Real-Time Position Adjustment

Sensor Integration: Connect the sensors to continuously track each viewer's position relative to the screen. These sensors gather real-time data, which is fed into the mask software to adjust content accordingly.

Dynamic Content Allocation: The digital mask dynamically adjusts the image for each viewer based on their viewing angle. The person directly in front sees the intended content, while viewers at different angles either see distinct content or no content (depending on configuration).

### Step 3: Light Emission Control

Light Manipulation: The algorithm modifies the light emitted from the screen to direct it toward specific viewing angles. By controlling light paths, Viewer 1 sees Image 1, and Viewer 2 sees Image 2 without interference.

Optimization: Fine-tune the algorithm to control light emissions, minimizing distortion for off-angle viewers while maintaining clarity for direct viewers.

### Hardware-Software Synchronization

### Step 1: Integrating Display Hardware with Software

Directional Light Display: Parallax barrier or lenticular display technology works in conjunction with the software. The screen directs light to specific angles based on instructions from the digital mask.

Synchronize with GPU: The GPU handles real-time rendering, applying the digital mask to each frame, ensuring content shifts dynamically based on viewer movement.

### Step 2: Real-Time Feedback Loop

Calibrate Display for Multiple Viewers: Set up the sensors to track multiple users and create a seamless feedback loop between the sensors and the software. The display adjusts dynamically to ensure each person sees their designated content.

Continuous Update Cycle: The system must continuously update the image as viewers move or adjust their position, requiring efficient processing to handle sensor inputs and modify the screen output in real-time.

### How to Use the Invention

### Step 1: Initial Setup and Calibration

Power Up and Calibrate: Upon powering the device, it enters calibration mode, where sensors scan the surrounding area to detect viewer positions. The system records these angles in real-time to map out where light and content should be directed.

Choose Content: Users select their preferred content (e.g., movies, presentations, games), and the system assigns content to each viewer, adjusting light output based on their angles.

### Step 2: Display Management and Real-Time Adjustment

Display Dynamic Content: Once calibrated, the screen displays distinct images to each viewer. The light paths are adjusted using the digital mask, ensuring each viewer sees only their assigned content without overlap.

Sensor-Driven Adjustments: As viewers move, gyroscopes and accelerometers detect these changes, dynamically adjusting the display to maintain the correct content for each angle.

### Step 3: User Customization

User Interaction: Users can interact through touch-based or physical controls, fine-tuning their viewing experience by adjusting brightness, contrast, or switching between different content streams. This adds a layer of personalization to the viewing experience.

### Step 4: Real-Time Usage Scenarios

Home Entertainment: Two people can watch different content on the same TV. Viewer 1 watches a sports game while Viewer 2 watches a movie. As they move, the system adapts to their position, ensuring that each sees only their content.

Retail and Public Display: In a retail store, one customer sees a promotional video, while another sees product details. This allows for different messages to be delivered to different customers based on viewing position.

### Advanced Features and Enhancements

### Enhanced Viewing Angle Management

Viewing Angle Customization: Users can adjust the range of viewing angles for content delivery. For example, the system could restrict the display to a 15-degree range, ensuring that only viewers in this narrow field can see the content.

### Multi-User Support

Multiple Users: The system supports multiple viewers by expanding its capacity to handle multiple light projection paths and digital masks. For example, three users can watch three different videos on the same display, with content adjusted to each viewer's angle.

### Privacy Mode

Privacy Enhancement: The system can include a privacy mode that ensures sensitive information is displayed only to specific users. Others will see a blank screen or generic content, making it ideal for financial or healthcare environments where confidentiality is essential.

The invention offers a revolutionary approach to multi-viewing experiences by combining advanced display technologies with real-time sensor input and light manipulation. Its ability to display two different images to two viewers based on their viewing angles is powered by a sophisticated combination of hardware and software working in unison to deliver an adaptable, immersive viewing experience. Whether used in entertainment, education, or commercial environments, this system provides a highly customized, flexible solution that enhances both usability and privacy for viewers.

### Real-Time Processing Overhead

Video Frame Rate: Videos typically run at 30 to 60 frames per second (fps), and applying a linear mask to each frame in real-time demands significant processing power. High-resolution videos (e.g., 4K or higher) increase the number of pixels that need processing, potentially causing frame drops, delays, or stuttering in playback.

High-Resolution Images: Processing high-resolution images similarly increases the computational load, particularly on devices with limited GPU or central processing unit (CPU) power, which may slow down mask application, reducing performance and image quality.

### GPU vs. CPU Processing

GPU Acceleration: Applying a linear mask benefits significantly from GPU acceleration, which is optimized for parallel processing and handling large volumes of pixel data. On devices with modern GPUs, such as high-end smartphones or computers, speed issues are mitigated. However, older or less powerful devices may struggle with the processing load.

CPU Bottleneck: If the CPU rather than the GPU handles processing, it may become a bottleneck. CPUs are not optimized for high-speed, pixel-by-pixel image manipulation, and the application of a linear mask, particularly with additional effects like contrast adjustment and color enhancement, may cause slowdowns.

### Software Optimization

Efficiency of the Algorithm: The performance of the linear mask relies heavily on the software algorithm's efficiency. An optimized algorithm with effective data handling and parallel processing can minimize performance issues, while poorly optimized software can lead to slowdowns, especially in resource-constrained environments.

Real-Time Adjustments: When the mask adjusts dynamically in response to user movement or changing ambient light, the additional processing required for continuous updates further increases the computational demand.

### Device-Specific Considerations

Mobile Devices vs. Desktops: High-end desktops and laptops generally have more powerful GPUs and CPUs that can manage real-time linear mask processing with ease. However, mobile devices—with their lower processing power—may experience challenges, including increased energy consumption and thermal throttling, which can reduce effective processing speed as the device manages heat and battery life.

### Energy Efficiency Concerns

Power Consumption: Continuously applying a linear mask in real-time, particularly for video content, draws significant power from mobile devices, leading to faster battery drain. Devices relying on real-time sensor inputs, such as motion detection or ambient light sensors, will consume more power, adding to energy efficiency concerns.

### Mitigating Speed Issues

Using Efficient Libraries: Leveraging efficient video and image processing libraries, such as OpenCV or GPU-accelerated frameworks like Vulkan or Metal, can significantly reduce the processing overhead, improving overall system performance.

Adaptive Processing: Applying the mask only to specific regions of interest—such as the center of the screen or sensitive areas—can reduce computational load and enhance speed, especially in resource-constrained environments.

Preprocessing: Preprocessing static content, such as photos, can mitigate speed issues, as the linear mask can be applied once rather than continuously. For video content, buffering frames and applying the mask ahead of real-time can also reduce the processing demand.

### Directional Light Control and Multi-View Display Technology

### Directional Light Control

Concept: Technologies like parallax barriers and lenticular displays already allow different content to be shown to viewers at different angles by directing light in specific directions.

Adaptation: The invention's digital mask technology can be combined with directional light control to manage which content is shown at different angles. By selectively applying masks, the screen can display one image to one angle and another to a different angle.

### Applying Different Masks for Different Angles

Mask Customization: The invention can be enhanced to apply different masks based on the viewer's angle, selectively controlling contrast, reflection, and brightness to show different images from different angles.

Real-Time Adjustment: Using sensors like gyroscopes and cameras to detect viewer position and angle, the invention can dynamically adjust the masks for different sections of the screen, ensuring that distinct content is displayed to each viewer based on their location.

### Multi-View Display Technology

Lenticular and Parallax Barrier Displays: These display types use physical light filters or lenses to direct light in specific directions. When combined with the digital mask, these technologies can provide precise control, enabling each viewer to see distinct content from different angles, similar to glasses-free 3D displays but with entirely different content.

Example Use Case: In a retail environment, one customer may see a promotional video while another sees product details from a different angle on the same screen.

### Software and Hardware Integration

Software Coordination: The digital mask must work in tandem with hardware, such as multi-view displays, to ensure that each viewer sees the correct content. The mask applies visual effects and controls the image seen by each viewer, while the hardware directs light accordingly.

Advanced Implementation: By dividing the screen into segments and controlling which pixels are visible at specific angles, the invention ensures distinct content is shown to different viewers. For example, a family could watch two different TV shows on the same screen depending on where they are sitting.

### Challenges and Considerations

Resolution Reduction: One potential challenge is that multi-view systems may reduce effective resolution per viewer, as pixels are divided between different angles.

Viewing Angles: The system works best when the number of different viewing angles is limited and clearly defined. Managing more than two perspectives may reduce image quality for each viewer and increase system complexity.

Adaptation for Multi-View Purposes: While the current focus of the invention is on improving privacy through dynamic display adjustments, the technology can be adapted for multi-view purposes. By combining digital masks with directional light control, the invention could allow two or more people to view different content from the same screen. This adaptation would require integration with hardware like lenticular or parallax displays, but it is technologically feasible, offering new possibilities for shared viewing environments.

### Key Use Cases

### Home Entertainment

Dual Content Viewing: Families or roommates can enjoy different TV shows or movies on the same screen without interference. For example, one person can watch a movie while another plays a video game, with the display dynamically adjusting to their respective positions.

Gaming: In multiplayer gaming, two players could see different views of the same game on a shared screen, eliminating the need for split-screen formats. Each player would see only their perspective, enhancing immersion and gameplay experience.

### Retail and Advertising Displays

Personalized Advertising: In retail environments or public spaces, viewers standing at different angles in front of a screen can see different advertisements or product information. For example, one viewer might see a promotional video, while another sees pricing and technical details, maximizing the impact of digital advertising.

Interactive Product Demos: In electronics stores, multiple customers could view different product features simultaneously. For instance, one viewer might see a demo of a smartphone's camera, while another views a tutorial on its operating system, providing a richer shopping experience.

### Collaborative Workspaces

Shared Presentations: In office settings or conference rooms, two collaborators can view different presentations or data on the same screen, improving efficiency. One person might review financial reports while another analyzes charts, without the need for separate monitors.

Video Conferencing: During meetings, one person could view the video conference with remote participants while another sees relevant documents or presentations on the same shared screen, streamlining communication and reducing device clutter.

### Education and Training

Dual-Lesson Teaching: In classrooms, teachers can display different lessons or videos to students sitting in different sections. For example, one group can watch a science documentary, while another group sees a math tutorial, enabling personalized learning from the same display.

Interactive Learning: In training environments, learners could see content tailored to their experience level or role. An instructor could show beginner-level instructions to one viewer and advanced content to another, all from the same screen, enhancing the training process.

### Healthcare

Patient and Doctor Displays: In medical consultations, a shared screen could show diagnostic information to the doctor while displaying simplified instructions or educational content to the patient, improving communication and understanding.

Confidential Viewing: In hospital rooms, confidential patient data could be shown to healthcare providers while visitors or other patients see general information or entertainment on the same screen, ensuring privacy and security of sensitive information.

### Public Information Kiosks

Personalized Directions: In airports, shopping malls, or public transport stations, two users can receive personalized directions or information from a single kiosk. One person might see travel directions, while another sees nearby dining options.

Multilingual Support: Public kiosks can display content in multiple languages simultaneously, allowing two users to access information in their native language without needing separate systems.

### Automotive Displays

Driver and Passenger Displays: A shared in-car screen could provide navigation and vehicle controls for the driver while showing entertainment for the passenger. This keeps the driver focused on driving, while both users can interact with the same display.

Heads-Up Displays: Heads-up displays in cars could show different information to the driver and front-seat passenger. The driver could view navigation, while the passenger sees entertainment or trip details, ensuring a clutter-free visual experience for both.

### Museum and Exhibition Displays

Interactive Exhibits: Museums and exhibitions can offer tailored multimedia content to visitors based on their position. One viewer could see historical facts, while another views a 3D animation of the same artifact, providing an immersive, educational experience.

Tourist Information: Tourist centers could display different guides, maps, or facts based on individual preferences or language, offering a customized experience for each visitor from a single shared screen.

### Financial Services

Private and Public Viewing: In bank branches or ATMs, a financial advisor could view sensitive client data on a shared screen while the client sees general summaries or educational content, maintaining privacy without requiring separate devices.

Dual Customer Service: Financial institutions can use the technology to display different promotions or financial products to clients, while service representatives view internal information, improving customer service and efficiency.

The invention offers versatility across various industries, including entertainment, advertising, education, healthcare, and public information systems. By personalizing content for multiple users on a shared screen, it enhances privacy, collaboration, and efficiency, making it a powerful tool in both consumer and professional environments.

In a preferred embodiment of the present invention, there is a method for displaying distinct images on a single screen to multiple viewers positioned at different angles. The method includes receiving multiple image or video data inputs, generating and applying numerical masks to different pixel groups on the screen, and dynamically adjusting the directionality of emitted light to control which viewer sees which content. Real-time sensor feedback, such as from gyroscopes or accelerometers, allows continuous updates to the masks and light directionality, ensuring a seamless multi-view experience.

In an alternate embodiment of the present invention, the numerical masks are generated based on algorithms that consider pixel arrangement, viewer angles, and content characteristics.

These algorithms allow the system to optimize visibility and clarity for each viewer while minimizing image overlap or interference between multiple viewers. This ensures that content is tailored to each viewer's position without disrupting others' experiences.

In an alternate embodiment of the present invention, the sensors used to track viewer positions include a variety of position-tracking devices such as gyroscopes, infrared sensors, ultrasonic sensors, and cameras. These sensors provide continuous real-time feedback about each viewer's head position, eye gaze, and distance from the screen, allowing the system to dynamically adjust the display based on this data.

In an alternate embodiment of the present invention, variations in ambient lighting conditions are detected, and the system adjusts the numerical masks and light directionality to optimize visibility under different environmental lighting conditions. This ensures that both images remain visible, even in challenging lighting environments, while protecting sensitive information.

In an alternate embodiment of the present invention, the light directionality is controlled by technologies such as lenticular lenses, parallax barriers, micro-lens arrays, or digital holography elements. These technologies allow precise control over which images are projected to specific viewing angles, ensuring that viewers see distinct content without overlap.

In an alternate embodiment of the present invention, the system detects the orientation and movement of the head and eye gaze of each viewer using biometric sensors. Based on this biometric data, the numerical masks and light directionality are adjusted to maintain optimal image clarity and visibility for each viewer, even as they move relative to the screen.

In an alternate embodiment of the present invention, a user interface is provided, allowing each viewer to manually select or customize the content displayed at their respective viewing angles. The interface includes options to adjust brightness, contrast, and color settings, offering personalized control over the viewing experience.

In a preferred embodiment of the present invention, there is a system for displaying distinct images to multiple viewers on a single screen. The system includes a display device with integrated directional light control technology, such as lenticular lenses or parallax barriers, and a plurality of position-detecting sensors connected to the display. A processor applies numerical masks to groups of pixels, controls light directionality, and continuously updates the display based on real-time feedback from the sensors.

In an alternate embodiment of the present invention, the directional light control technology is selected from lenticular lenses, parallax barriers, micro-lens arrays, or holography elements, allowing for precise projection of light to different viewing angles. This ensures that each viewer receives a high-resolution image tailored to their position.

In an alternate embodiment of the present invention, the system compensates for changes in ambient lighting conditions by adjusting the numerical masks and light directionality. This feature maintains optimal image visibility for each viewer, ensuring that both content clarity and privacy are preserved across a range of lighting environments.

In an alternate embodiment of the present invention, a user interface is connected to the processor, allowing each viewer to manually customize the image or video content displayed at their respective viewing angles. Viewers can adjust image settings such as brightness, contrast, and color, providing a personalized and adaptable viewing experience.

In an alternate embodiment of the present invention, the sensors used to track viewer positions include gyroscopes, infrared sensors, ultrasonic sensors, cameras, and eye-tracking devices. These sensors continuously monitor the viewer's position, head orientation, and eye gaze, ensuring that the system dynamically adjusts the display to maintain the correct content for each viewer.

In an alternate embodiment of the present invention, the processor utilizes real-time data from the sensors to dynamically adjust the directionality of emitted light and the numerical masks. This ensures that as viewers move or change position, the image clarity is maintained, preventing interference between different viewing angles.

In a preferred embodiment of the present invention, there is a non-transitory computer-readable medium storing instructions that, when executed by a processor, cause a display device to perform a method for displaying distinct images to multiple viewers positioned at different angles. The method includes receiving image or video data inputs, applying numerical masks to different pixel groups, and adjusting the directionality of light emission to ensure each viewer sees only their assigned image.

In an alternate embodiment of the present invention, the instructions stored on the non-transitory computer-readable medium enable the processor to adjust the numerical masks and light directionality to compensate for changes in ambient lighting conditions. This ensures that image visibility is maintained, even under varying lighting environments.

In an alternate embodiment of the present invention, the instructions allow the processor to track viewer positions, head movements, and eye gaze using biometric sensors. The processor then dynamically adjusts the image display based on this real-time data to ensure each viewer sees the correct content as they move relative to the screen.

In an alternate embodiment of the present invention, the non-transitory computer-readable medium includes instructions for providing a user interface that allows viewers to manually select, customize, or switch between different image or video inputs. This feature offers greater flexibility and control, allowing viewers to tailor the display to their preferences.

In a preferred embodiment of the invention, there is a method for displaying distinct images on a single screen to multiple viewers positioned at different viewing angles, comprising: receiving a plurality of image data inputs, including at least a first image data input and a second image data input, or a plurality of video data inputs, including at least a first video data input and a second video data input, each corresponding to a distinct content; generating and applying a set of numerical masks to different pixel groups of said single screen, wherein each numerical mask in said set of numerical masks is configured to control a brightness, a contrast, a color, and a pixel visibility to optimize a display of one of said plurality of image data inputs or said plurality of video data inputs to one of said multiple viewers; dynamically adjusting a directionality of emitted light from said single screen to direct specific light beams toward said different viewing angles, ensuring that a first viewer at a first angle primarily views a first image and a second viewer at a second angle primarily views a second image, with a capacity to serve two or more viewers depending on a refresh speed and processing capabilities of a display hardware; and utilizing a real-time position data obtained from at least one sensor to continuously update said set of numerical masks and a light directionality in response to detected changes in a position and a viewing angle of each of said multiple viewers.

In an alternate embodiment of the invention, there is a method for displaying distinct images on a single screen to multiple viewers positioned at different viewing angles wherein said set of numerical masks are generated based on algorithms that consider a pixel arrangement, said viewing angle, and content characteristics to optimize a visibility and clarity of an image for a respective viewer while minimizing an image overlap or an interference between said multiple viewers.

In an alternate embodiment of the invention, there is a method for displaying distinct images on a single screen to multiple viewers positioned at different viewing angles wherein said sensors comprise a plurality of position-tracking devices selected from a group consisting of gyroscopes, infrared sensors, cameras, ultrasonic sensors, and eye-tracking devices, and wherein said real-time position data is continuously updated to reflect changes in a head position, an eye gaze, and a distance from said single screen of said multiple viewers.

In an alternate embodiment of the invention, there is a method for displaying distinct images on a single screen to multiple viewers positioned at different viewing angles further comprising detecting variations in ambient lighting conditions and adjusting said set of numerical masks and said light directionality to enhance an image visibility under different environmental lighting conditions.

In an alternate embodiment of the invention, there is a method for displaying distinct images on a single screen to multiple viewers positioned at different viewing angles wherein said light directionality is controlled by a directional light management technology selected from a group consisting of lenticular lenses, parallax barriers, micro-lens arrays, or digital holography elements, integrated with said single screen to project light beams toward said different viewing angles.

In an alternate embodiment of the invention, there is a method for displaying distinct images on a single screen to multiple viewers positioned at different viewing angles further comprising: detecting an orientation and a movement of a head and an eye gaze of each of said multiple viewers using a biometric sensor; and dynamically adjusting said set of numerical masks and said light directionality based on a biometric data from said biometric sensor to maintain optimal image clarity and visibility for each of said multiple viewers as each of said multiple viewers move relative to said single screen.

In an alternate embodiment of the invention, there is a method for displaying distinct images on a single screen to multiple viewers positioned at different viewing angles further comprising providing a user interface enabling each of said multiple viewers to manually select or customize an image content or a video content displayed at the respective viewing angles of each of said multiple viewers, including options to adjust image settings such as said brightness, said contrast, said color, and said pixel visibility.

In a preferred embodiment of the invention, there is a system for displaying distinct images to multiple viewers on a single screen, comprising: a display device with an integrated directional light control technology capable of emitting light toward a plurality of specific viewing angles, including at least a first specific viewing angle and a second specific viewing angle; a plurality of position-detecting sensors, including at least a first position-detecting sensor and a second position-detecting sensor, operatively connected to said display device, said plurality of position-detecting sensors configured to detect a position, a viewing angle, a head movement, and an eye gaze of each of a plurality of viewers, including at least a first viewer and second viewer, relative to said single screen; and a processor operatively connected to said display device and said plurality of position-detecting sensors, said processor configured to: apply a set of numerical masks to distinct groups of pixels on said single screen, each numerical mask in said set of numerical masks corresponding to one of an image data input or a video data input and controlling a pixel brightness, a contrast, a color, and a visibility to optimize an image clarity for each of said plurality of viewers; adjust a light directionality of said display device to ensure that said distinct images are projected to said plurality of specific viewing angles, ensuring that each of said plurality of viewers sees only an assigned image of each of said plurality of viewers, with a capability to serve two or more viewers depending on a processing speed of said system; and continuously update said set of numerical masks and said light directionality based on real-time feedback from said plurality of position-detecting sensors, thereby optimizing a display for each of said plurality of viewers in a respective position and a respective viewing angle.

In an alternate embodiment of the invention, there is a system for displaying distinct images to multiple viewers on a single screen wherein said integrated directional light control technology is selected from a group consisting of lenticular lenses, parallax barriers, micro-lens arrays, and holography elements, wherein said integrated directional light control technology is integrated with pixel arrays capable of projecting high-resolution images to a plurality of different viewing angles, including at least a first different viewing angle and a second different viewing angle.

In an alternate embodiment of the invention, there is a system for displaying distinct images to multiple viewers on a single screen wherein said processor is configured to compensate for changes in ambient lighting conditions by adjusting said set of numerical masks and said light directionality to maintain optimal image visibility for each of said plurality of viewers.

In an alternate embodiment of the invention, there is a system for displaying distinct images to multiple viewers on a single screen further comprising a user interface connected to said processor, wherein said user interface allows each of said plurality of viewers to manually customize an image content or a video content displayed at said respective viewing angle, including an option to adjust image settings such as said pixel brightness, said contrast, and said color.

In an alternate embodiment of the invention, there is a system for displaying distinct images to multiple viewers on a single screen wherein said plurality of position-detecting sensors are selected from a group consisting of gyroscopes, infrared sensors, ultrasonic sensors, cameras, and eye-tracking devices, and wherein said plurality of position-detecting sensors continuously track said position, said head movement, and said eye gaze of each of said plurality of viewers.

In an alternate embodiment of the invention, there is a system for displaying distinct images to multiple viewers on a single screen wherein said processor further utilizes real-time data from said plurality of position-detecting sensors to dynamically adjust said light directionality and said set of numerical masks to compensate for a viewer movement, ensuring that an image clarity is maintained even as said plurality of viewers change position or angle.

In a preferred embodiment of the invention, there is a non-transitory computer-readable medium storing instructions that, when executed by a processor, cause a display device to perform a method for displaying distinct images to viewers positioned at different angles, said method comprising: receiving a plurality of image data inputs, including at least a first image data input and a second image data input, and a plurality of video data inputs, including at least a first video data input and a second video data input; applying a set of numerical masks to different groups of pixels on said display device, wherein each numerical mask is associated with one of said image data input or video data input and is configured to control a brightness, a contrast, and a visibility of pixels based on a respective position of each of said viewers; adjusting a light directionality of said display device to project distinct images to different viewing angles based on real-time sensor feedback; and continuously updating said set of numerical masks and said light directionality based on changes in a viewer position and a viewing angle detected by position-tracking sensors.

In an alternate embodiment of the invention, there is a method for displaying distinct images to viewers positioned at different angles wherein said instructions further enable said processor to adjust said set of numerical masks and said light directionality to compensate for changes in ambient lighting conditions, ensuring an optimal image visibility under varying lighting environments.

In an alternate embodiment of the invention, there is a method for displaying distinct images to viewers positioned at different angles wherein said instructions further enable said processor to track a head position, an eye gaze, and a movement of said viewers using biometric sensors and adjust an image display dynamically to maintain optimal image visibility.

In an alternate embodiment of the invention, there is a method for displaying distinct images to viewers positioned at different angles wherein said instructions further enable a user interface to allow said viewers to manually select, customize, or switch between different image or video data inputs based on a respective viewing angle of said viewers.

### Enhanced Features of the Present Invention

Numerical Masks: Expanded to include control over brightness, contrast, color, and pixel visibility, allowing precise image management across different viewing angles.

Sensor Integration: Real-time adjustments based on data from various sensors (gyroscopes, infrared, cameras, eye-tracking, and ambient light) ensure a seamless display experience as viewers move or environmental conditions change.

Biometric Feedback: Adding biometric sensor integration (such as head orientation and eye gaze tracking) allows the system to dynamically adjust the display based on viewer behavior, ensuring an adaptive and responsive experience.

User Customization: Viewers can manually select or customize their displayed content via a user interface, enhancing interactivity and personalization.

Environmental Adaptation: The system adapts to changes in ambient lighting, ensuring that image clarity and brightness are maintained under varying conditions.

Non-Transitory Medium: The software implementation is explicitly described in a non-transitory computer-readable medium claim, securing broad protection for the software aspects of the invention.

This invention introduces several key differentiators compared to prior art:

Dynamic Numerical Masking: In a preferred embodiment of the present invention, numerical masks are used to manipulate specific pixels on a single screen to display different images to viewers at different angles. Prior art typically relies on static multi-view displays, such as lenticular lenses or parallax barriers, without leveraging numerical masking to fine-tune the visibility of the images. This invention dynamically adjusts pixel visibility based on real-time input from sensors, providing a more precise and adaptive viewing experience.

Real-Time Angle Detection and Adjustment: In an alternate embodiment of the present invention, real-time feedback from sensors such as gyroscopes, infrared sensors, or cameras is used to detect the exact viewing angles of the viewers. This data is continuously processed to dynamically adjust the numerical masks to optimize image visibility for each viewer. While prior art may use fixed or semi-fixed methods to direct light toward specific angles, they typically lack the ability to adapt in real-time based on precise viewer positions.

Multi-Viewer Support Beyond Basic Two-Angle Display: In a preferred embodiment of the present invention, the system supports more than just two viewing angles, allowing multiple viewers (e.g., three or more) to see different images on the same screen. Prior art is often limited to displaying two images—one for the left viewer and one for the right viewer—using lenticular lenses. The present invention, however, employs specific control over light directionality and pixel-specific masking, enabling more flexible and customizable viewing angles for multiple users.

Enhanced Image Control through Light Directionality: In an alternate embodiment of the present invention, control over the directionality of light ensures that each image is primarily visible only to the designated viewer at their specific angle. Prior art often segments the display regions or beams but does not offer the same level of precision in controlling which specific viewer sees which content, especially in crowded environments. This invention uses light manipulation to ensure that only the intended user sees the designated content.

Numerical Mask Application for Specific Pixel Management: In an alternate embodiment of the present invention, numerical masks are applied to adjust brightness, contrast, and color for specific pixel groups, improving image clarity for individual viewers based on their viewing angles. Unlike prior art that relies on the inherent optics of display technology (e.g., lenticular or parallax solutions), this invention introduces a software-driven approach for fine-tuning pixel management, creating a more dynamic and adaptive display experience.

Adaptability to User Customization: In a preferred embodiment of the present invention, the system includes a user interface that allows viewers to customize which image they see based on their preferences. This customization is integrated with dynamic numerical masking and sensor feedback, creating a tailored viewing experience that is generally absent in prior multi-view display systems. The ability to adjust settings like brightness, contrast, and content selection sets this invention apart from traditional static systems.

Summary of Differentiation: In summary, this invention's distinctiveness lies in its adaptive, real-time control over image visibility through a combination of numerical masks, light directionality, and sensor feedback. This advanced system goes beyond the fixed or less dynamic approaches commonly seen in prior art, providing a more flexible, precise, and interactive solution for displaying different content to multiple viewers on a single screen.

The invention is significantly more than just software because it integrates hardware components and physical processes to achieve a specific, tangible result-namely, displaying different images to multiple viewers on a single screen based on their viewing angles. Here's a breakdown of why this invention goes beyond being purely software:

Hardware Involvement: In a preferred embodiment of the present invention, several key hardware components are integrated into the system: Display Device: The invention involves a physical display device supporting directional light control, such as lenticular lenses or parallax barriers. These elements physically manipulate light emitted from the screen, and the software (numerical masking and image control) directly influences their functioning to manage the content visible at each viewing angle. Sensors: The system includes sensors such as gyroscopes, infrared sensors, and cameras to detect the physical position and angle of each viewer relative to the screen. These sensors are physical components integrated into the system, providing real-time feedback that the software uses to adjust the image accordingly. Processor: A processor executes the software instructions to adjust the display in real time based on sensor input. The processor coordinates the display, sensors, and numerical masking, making the invention a complete hardware-software system.

Interaction with the Physical World: In an alternate embodiment of the present invention, manipulation of light emitted from the screen, a physical phenomenon, is dynamically controlled by the software. The system alters the pixel brightness, contrast, and hue for each viewer based on their position, affecting the viewing experience of real-world users in a tangible way. This interaction between software, hardware, and the physical world differentiates the invention from purely abstract software applications.

Technical Solution to a Hardware Problem: In a preferred embodiment of the present invention, a technical solution is provided to the hardware challenge of displaying different content to multiple viewers on a single screen. The invention combines hardware (directional light control, sensors) with software (numerical masking and real-time adjustments) to achieve this goal. The problem of delivering distinct images to different viewers based on angle requires both hardware and software elements to function together, a challenge not solvable by software alone.

Real-Time Feedback and Adaptation: In an alternate embodiment of the present invention, real-time sensor feedback is used to detect viewer positions, influencing how the software adjusts the display. This continuous feedback loop between physical sensors and the software allows the display to be dynamically modified based on real-world data, enhancing the user experience.

Customization Through a User Interface: In a preferred embodiment of the present invention, the system includes a user interface allowing viewers to customize their experience based on their viewing angle. This feature requires interaction with physical hardware (the display and sensors) and allows users to control the content they see, adding a layer of personalization that is absent from typical software-only systems.

Physical Constraints and Engineering Considerations: In an alternate embodiment of the present invention, the design considers engineering constraints related to light directionality, pixel management, and sensor accuracy. These are physical challenges that the software must work within to optimize the hardware output, showcasing the integration between the digital and physical components.

Numerical Mask and Hardware Interaction: In a preferred embodiment of the present invention, the numerical mask is used to manage the pixel-level output on the display, aligning with the physical hardware's capabilities to direct light toward different angles. The interaction between software and hardware is crucial for ensuring that the correct content is delivered to each viewer.

Hardware-Specific Problem Solving: In an alternate embodiment of the present invention, solving problems such as resolution management, light direction, and sensor integration requires more than just software—it demands careful coordination between the hardware (screen and sensors) and software algorithms. This approach goes beyond abstract concepts and into real-world, hardware-dependent execution.

The present invention is significantly more than just software. It integrates with and controls physical hardware components, including sensors, processors, and display technologies, to produce a specific technical result—displaying different images to different viewers based on their viewing angles. This invention operates at the intersection of hardware and software, solving a tangible problem that goes beyond the scope of software alone.

The claims of the present invention outline a method and system for using digital mask technology to display two different images to viewers positioned at different angles in front of the same screen. The system leverages directional light control, real-time sensor feedback, and numerical masks to adjust the visibility of each image, ensuring that each viewer sees only the intended content from their respective angle. The invention can be applied to multi-view displays, enabling diverse applications such as multi-user gaming, public information displays, and shared media experiences on a single screen. This allows for personalized and secure content delivery without the need for multiple displays.

The claims of the present invention define a method and system for using a numerical mask to control the visibility of digital images and videos based on viewer position. The primary functions include dynamically adjusting content delivery by selectively applying contrast changes, reducing reflections, and enhancing colors in specific regions of the screen. This approach ensures that each viewer experiences optimized content visibility. The claims cover various aspects, including multi-angle gradient application, real-time sensor-based adjustments, and user customization, providing a comprehensive framework for implementing multi-view technology across various digital imaging devices and platforms, such as smartphones, tablets, and large public displays.

The claims of the present invention focus on using a digital mask to deliver different images to multiple viewers based on their viewing angles, with the specific goal of enhancing personalization and content differentiation on screens used in smartphones, tablets, and computers. The key aspects include controlling the display of content by adjusting the screen's contrast, light directionality, and color saturation. This ensures that each viewer sees distinct content from different viewing angles, while making it difficult for other users to view content not intended for them, thus improving privacy and security.

The claims of the present invention also address dynamic adjustments based on environmental factors, such as ambient light, and user-defined controls, which enable users to customize their viewing preferences. This ensures that the system adapts to a variety of viewing conditions and use cases, offering flexibility and personalization in both indoor and outdoor environments. Whether used for home entertainment, professional collaboration, or public information, the invention allows for a more tailored and secure multi-view experience on a single digital display platform.

The invention presents several advantages over existing technologies and effectively addresses persistent problems in prior art.

Personalized Multi-View Experience: Enhanced Usability for Shared Devices: The ability to display two distinct images simultaneously allows multiple users to interact with the same device without interference. Whether in gaming, public displays, educational environments, or collaborative workspaces, users can enjoy personalized experiences without needing additional screens. For example, one viewer can watch a video, while another interacts with different content, enhancing the versatility of shared screens. Individual User Experiences: This functionality caters to scenarios where different viewers require separate information, such as in public information kiosks or multi-user gaming systems. Users can receive content tailored to their needs (e.g., tourist information versus advertisements) without disruption or content overlap.

Dynamic Real-Time Adjustments: Seamless Adaptation to Viewing Angles: The system integrates real-time sensors, including gyroscopes, accelerometers, and ambient light detectors, to dynamically adjust the display based on users' positions relative to the screen. This ensures that each viewer sees the correct content as they move, creating a fluid experience without interruptions. Unlike prior systems that require manual recalibration, this dynamic adjustment eliminates the need for fixed, pre-set positions, offering more flexibility for real-world scenarios where users may frequently change positions.

Environmental Adaptability: The system responds to changes in external conditions, such as ambient light, dynamically adjusting the display to ensure optimal visibility for all viewers. This adaptability makes the system suitable for both indoor and outdoor use, where lighting conditions may vary significantly.

Device Independence: Software-Driven, Platform-Agnostic Solution: This invention can be implemented through software, meaning it is compatible with a wide variety of devices, including smartphones, tablets, computers, and smart TVs. Users do not need to invest in specialized hardware, making this multi-view technology more accessible and cost-effective for both consumers and manufacturers. Cross-Platform Functionality: The invention can be integrated into existing devices via software updates, allowing it to be adopted across multiple platforms without requiring significant hardware changes. This versatility extends the invention's use cases, from consumer electronics to commercial displays in retail, entertainment, and information kiosks.

Enhanced Privacy and Usability: Selective Content Delivery: The invention not only offers personalization but also enhances privacy. Sensitive information can be hidden from unauthorized viewers by displaying different content based on the viewer's position. This is particularly useful in environments like banking kiosks, medical displays, or shared workspaces where private data needs to be protected while delivering general information to others. Maintaining Usability in Public and Private Settings: By selectively applying privacy-enhancing techniques like contrast adjustments, reflection reduction, and color adjustments, the invention ensures that critical content is easily visible to the intended user without compromising usability. Non-sensitive content remains visible to other users, maintaining a balance between privacy and functionality.

Improved Viewing in Various Conditions: High Ambient Light Optimization: Traditional displays often struggle with visibility under harsh lighting conditions, such as outdoors or in brightly lit rooms. This invention dynamically adjusts pixel brightness, contrast, and color saturation to optimize visibility from specific viewing angles, making it ideal for outdoor advertising, digital signage, and other applications requiring consistent performance in varying lighting conditions. Enhanced Visual Clarity and Reduced Reflection: The system reduces reflections and optimizes contrast, delivering a sharper, clearer image for each viewer. This improves readability and ensures that viewers can comfortably see their respective images without distractions from glare or poor contrast.

Cost-Effectiveness and Scalability: Low Cost of Implementation: The system leverages software and existing hardware components, such as sensors and display controllers, reducing the need for expensive, specialized multi-view hardware like parallax barriers or lenticular lenses. This cost-effective approach makes the system scalable across different industries, from consumer electronics to enterprise systems. Scalable to a Variety of Use Cases: The versatility of the invention allows it to be scaled across multiple industries, including entertainment, education, commercial displays, gaming, and collaborative workspaces. Its adaptability in delivering personalized content based on viewer angles makes it valuable for a range of applications benefiting from multi-view experiences.

Hybrid and Augmented Use: Compatibility with Existing Technologies: The invention can work in conjunction with physical privacy filters or multi-view displays, enhancing the viewing experience. For instance, it can be paired with physical privacy screens to further customize privacy protection or boost performance in environments requiring higher levels of privacy. Augmented Viewing Applications: The technology could be integrated with augmented reality (AR) systems to offer enhanced multi-view experiences. For example, multiple users could interact with a digital display that provides contextually relevant AR content based on their individual perspectives.

The invention's ability to deliver two distinct images to different viewers based on their viewing angles offers a personalized, cost-effective, and dynamic approach to multi-view technology. By integrating real-time sensors, enhancing privacy, improving performance in various lighting conditions, and remaining platform-independent, the invention represents a significant leap forward over existing technologies. Its flexibility and scalability make it well-suited to a wide variety of commercial and consumer applications, ensuring a more versatile and user-friendly experience.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1. A method for displaying distinct images on a single screen to multiple viewers positioned at different viewing angles, comprising:
receiving a plurality of image data inputs, including at least a first image data input and a second image data input, or a plurality of video data inputs, including at least a first video data input and a second video data input, each corresponding to a distinct content;
generating and applying a set of numerical masks to different pixel groups of said single screen, wherein each numerical mask in said set of numerical masks is configured to control a brightness, a contrast, a color, and a pixel visibility to optimize a display of one of said plurality of image data inputs or said plurality of video data inputs to one of said multiple viewers;
dynamically adjusting a directionality of emitted light from said single screen to direct specific light beams toward said different viewing angles, ensuring that a first viewer at a first angle primarily views a first image and a second viewer at a second angle primarily views a second image, with a capacity to serve two or more viewers depending on a refresh speed and processing capabilities of a display hardware; and
utilizing a real-time position data obtained from at least one sensor to continuously update said set of numerical masks and a light directionality in response to detected changes in a position and a viewing angle of each of said multiple viewers.

2. The method of claim 1, wherein said set of numerical masks are generated based on algorithms that consider a pixel arrangement, said viewing angle, and content characteristics to optimize a visibility and clarity of an image for a respective viewer while minimizing an image overlap or an interference between said multiple viewers.

3. The method of claim 1, wherein said sensors comprise a plurality of position-tracking devices selected from a group consisting of gyroscopes, infrared sensors, cameras, ultrasonic sensors, and eye-tracking devices, and wherein said real-time position data is continuously updated to reflect changes in a head position, an eye gaze, and a distance from said single screen of said multiple viewers.

4. The method of claim 1, further comprising detecting variations in ambient lighting conditions and adjusting said set of numerical masks and said light directionality to enhance an image visibility under different environmental lighting conditions.

5. The method of claim 1, wherein said light directionality is controlled by a directional light management technology selected from a group consisting of lenticular lenses, parallax barriers, micro-lens arrays, or digital holography elements, integrated with said single screen to project light beams toward said different viewing angles.

6. The method of claim 1, further comprising:
detecting an orientation and a movement of a head and an eye gaze of each of said multiple viewers using a biometric sensor; and
dynamically adjusting said set of numerical masks and said light directionality based on a biometric data from said biometric sensor to maintain optimal image clarity and visibility for each of said multiple viewers as each of said multiple viewers move relative to said single screen.

7. The method of claim 1, further comprising providing a user interface enabling each of said multiple viewers to manually select or customize an image content or a video content displayed at the respective viewing angles of each of said multiple viewers, including options to adjust image settings that include at least one of said brightness, said contrast, said color, and said pixel visibility.

8. A system for displaying distinct images to multiple viewers on a single screen, comprising:
a display device with an integrated directional light control technology capable of emitting light toward a plurality of specific viewing angles, including at least a first specific viewing angle and a second specific viewing angle;
a plurality of position-detecting sensors, including at least a first position-detecting sensor and a second position-detecting sensor, operatively connected to said display device, said plurality of position-detecting sensors configured to detect a position, a viewing angle, a head movement, and an eye gaze of each of a plurality of viewers, including at least a first viewer and second viewer, relative to said single screen; and
a processor operatively connected to said display device and said plurality of position-detecting sensors, said processor configured to:
apply a set of numerical masks to distinct groups of pixels on said single screen, each numerical mask in said set of numerical masks corresponding to one of an image data input or a video data input and controlling a pixel brightness, a contrast, a color, and a visibility to optimize an image clarity for each of said plurality of viewers;
adjust a light directionality of said display device to ensure that said distinct images are projected to said plurality of specific viewing angles, ensuring that each of said plurality of viewers sees only an assigned image of each of said plurality of viewers, with a capability to serve two or more viewers depending on a processing speed of said system; and
continuously update said set of numerical masks and said light directionality based on real-time feedback from said plurality of position-detecting sensors, thereby optimizing a display for each of said plurality of viewers in a respective position and a respective viewing angle.

9. The system of claim 8, wherein said integrated directional light control technology is selected from a group consisting of lenticular lenses, parallax barriers, micro-lens arrays, and holography elements, wherein said integrated directional light control technology is integrated with pixel arrays capable of projecting high-resolution images to a plurality of different viewing angles, including at least a first different viewing angle and a second different viewing angle.

10. The system of claim 8, wherein said processor is configured to compensate for changes in ambient lighting conditions by adjusting said set of numerical masks and said light directionality to maintain optimal image visibility for each of said plurality of viewers.

11. The system of claim 8, further comprising a user interface connected to said processor, wherein said user interface allows each of said plurality of viewers to manually customize an image content or a video content displayed at said respective viewing angle, including an option to adjust image settings comprising at least one of said pixel brightness, said contrast, and said color.

12. The system of claim 8, wherein said plurality of position-detecting sensors are selected from a group consisting of gyroscopes, infrared sensors, ultrasonic sensors, cameras, and eye-tracking devices, and wherein said plurality of position-detecting sensors continuously track said position, said head movement, and said eye gaze of each of said plurality of viewers.

13. The system of claim 8, wherein said processor further utilizes real-time data from said plurality of position-detecting sensors to dynamically adjust said light directionality and said set of numerical masks to compensate for a viewer movement, ensuring that an image clarity is maintained even as said plurality of viewers change position or angle.

14. A non-transitory computer-readable medium storing instructions that, when executed by a processor, cause a display device to perform a method for displaying distinct images to viewers positioned at different angles, said method comprising:
receiving a plurality of image data inputs, including at least a first image data input and a second image data input, and a plurality of video data inputs, including at least a first video data input and a second video data input;
applying a set of numerical masks to different groups of pixels on said display device, wherein each numerical mask is associated with one of said image data input or video data input and is configured to control a brightness, a contrast, and a visibility of pixels based on a respective position of each of said viewers;
adjusting a light directionality of said display device to project distinct images to different viewing angles based on real-time sensor feedback; and
continuously updating said set of numerical masks and said light directionality based on changes in a viewer position and a viewing angle detected by position-tracking sensors.

15. The method of claim 14, wherein said instructions further enable said processor to adjust said set of numerical masks and said light directionality to compensate for changes in ambient lighting conditions, ensuring an optimal image visibility under varying lighting environments.

16. The method of claim 14, wherein said instructions further enable said processor to track a head position, an eye gaze, and a movement of said viewers using biometric sensors and adjust an image display dynamically to maintain optimal image visibility.

17. The method of claim 14, wherein said instructions further enable a user interface to allow said viewers to manually select, customize, or switch between different image or video data inputs based on a respective viewing angle of said viewers.
